(19) United States
(12) Patent Application Publication
(10) Pub. No.: US 2022/0120309 A1
(43) Pub. Date: Apr. 21, 2022

(54) INTERNAL CONNECTOR SYSTEM FOR STRUCTURAL MEMBERS

(71) Applicant: Fortress Iron, LP, Garland, TX (US)

(72) Inventor: Ian A. Hill, Plano, TX (US)

(21) Appl. No.: 17/075,263

(22) Filed: Oct. 20, 2020

(51) Int. Cl. F16B 39/10; E04B 1/19

(52) U.S. Cl. CPC F16B 39/10; E04B 1/1903

(57) ABSTRACT

An internal connector system of structural member includes a locking screw with a screw thread. A connector block includes a first bore hole sized and shaped to receive at least a portion of the locking screw, and the connector block is configured to engage with a bolt thread of a bolt. A lock plate has a plate thread that is configured to engage the screw thread of the locking screw. Tightening the locking screw causes the connector block to expand the lock plate.

### CROSS-REFERENCE TO RELATED PATENT APPLICATIONS

This application is subject matter related to U.S. Patent Application with attorney docket number 670683-1047, entitled “Structural Post with Internal Connector System,” invented by the inventor named in this application, and filed concurrently herewith, the disclosure of which is hereby incorporated by reference.

### BACKGROUND

The present invention relates generally to the field of architectural construction, and more specifically to architectural construction of certain structures using alternative building materials, such as extruded structural members. Such building materials are particularly useful in construction of outdoor living structures, such as pergolas, gazebos, arbors, pavilions, and the like. Conventional fasteners were not designed to work with alternative building materials. A fastening system that takes advantage of features of extruded structural members would be useful.

### SUMMARY OF THE INVENTION

One embodiment of the invention relates to an internal connector system for structural members that includes a locking screw with a screw thread. A connector block includes a first bore hole sized and shaped to receive at least a portion of the locking screw, and the connector block is configured to engage with a bolt thread of a bolt. A lock plate has a plate thread that is configured to engage the screw thread of the locking screw. Tightening the locking screw causes the connector block to expand the lock plate. According to one embodiment, the connector block is formed from an extruded metallic material, such as an aluminum alloy. The internal connector system is sized and shaped to be received in a channel of an extruded structural member. Upon being received in the channel, the locking screw is tightened to expand the lock plate such that the lock plate impinges on walls of the channel. The interface between the lock plate and the walls of the channel secure the connector system internal to the structural member. The connector block includes features that allow it to receive a fastener, such as a bolt. The fasteners can penetrate a joining structural member, or the fasteners may be received through pre-drilled holes in the joining structural member. In this manner, fasteners can be used with the connector block of the present disclosure to secure structural members together. This summary is illustrative only and is not intended to be in any way limiting.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1A is a perspective view of a pergola in which certain individual structural members may be joined using the internal connector system of the present disclosure;

FIG. 1B is a detailed view of the pergola shown in FIG. 1A with portions broken away to show the internal features of a tiered post and an internal connector system according to the teachings of the present disclosure;

FIG. 1C is a detailed view of the post-to-beam connection with the post removed to show the disclosed internal connector system;

FIG. 1D is a detail view of certain structural members of the pergola shown in FIG. 1A;

FIG. 2A is a perspective view of an embodiment of an internal connector system according to the teachings of the present disclosure;

FIG. 2B is a perspective, exploded view of the embodiment of the internal connector system shown in FIG. 2A;

FIG. 3A is a perspective view and FIG. 3B is a side, elevation view of the connector block of the embodiment of the internal connector system shown in FIGS. 2A and 2B;

FIG. 4A is a perspective view and FIG. 4B is a side view of the lock plate of the embodiment of the internal connector system shown in FIGS. 2A and 2B;

FIG. 4C is a side view of the lock plate of FIG. 4B in an expanded configuration;

FIG. 5A is a front, elevation view of the internal connector system of FIGS. 2A and 2B showing the lock plate loosely connected to the connector block such that the lock plate is in a relaxed configuration;

FIG. 5B is a front, elevation view of the internal connector system shown in FIG. 5A with the lock plate in tight engagement with the connector block, such that the lock plate is in an expanded configuration;

FIG. 6A is a perspective view of the internal connector system of the present disclosure disposed within a channel of a first structural member, for example a perimeter beam;

FIG. 6B is a perspective view of the internal connector system of the present disclosure disposed within a channel of a second structural member, for example a crossbeam;

FIG. 7A is a perspective, exploded view of an alternate embodiment of an internal connector system according to the teachings of the present disclosure;

FIG. 7B is a cross-section of the connector block shown in FIG. 7A;

FIG. 8 is a perspective view of a pair of beams joined to a post using the internal connector system of the present disclosure;

FIG. 9A is a perspective, exploded view of a bold and tightening know that may be used with embodiments of the internal connector system of the present disclosure; and

FIG. 9B is a cross-section of the tightening knob shown in FIG. 9A.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

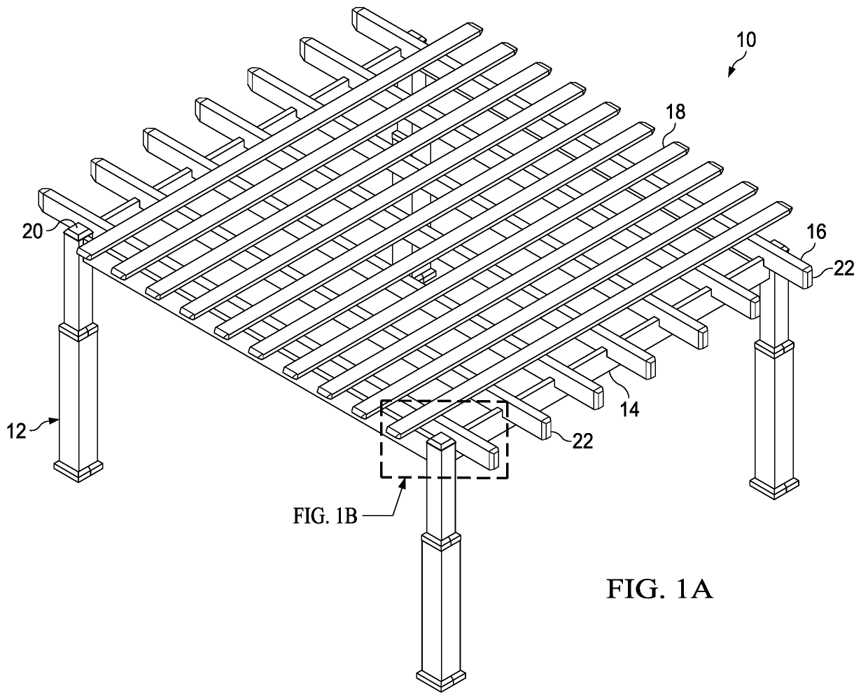

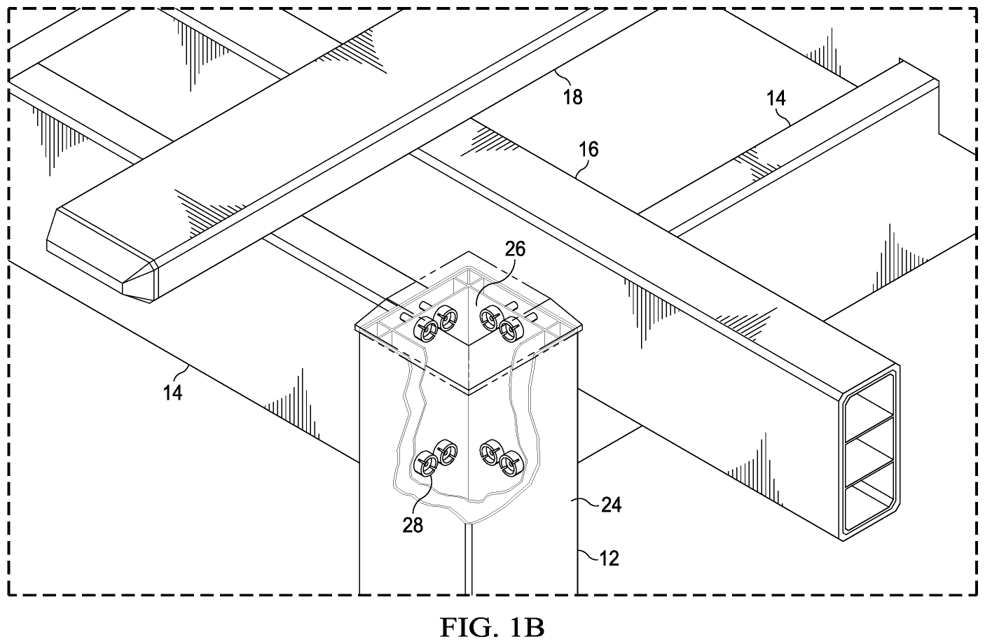

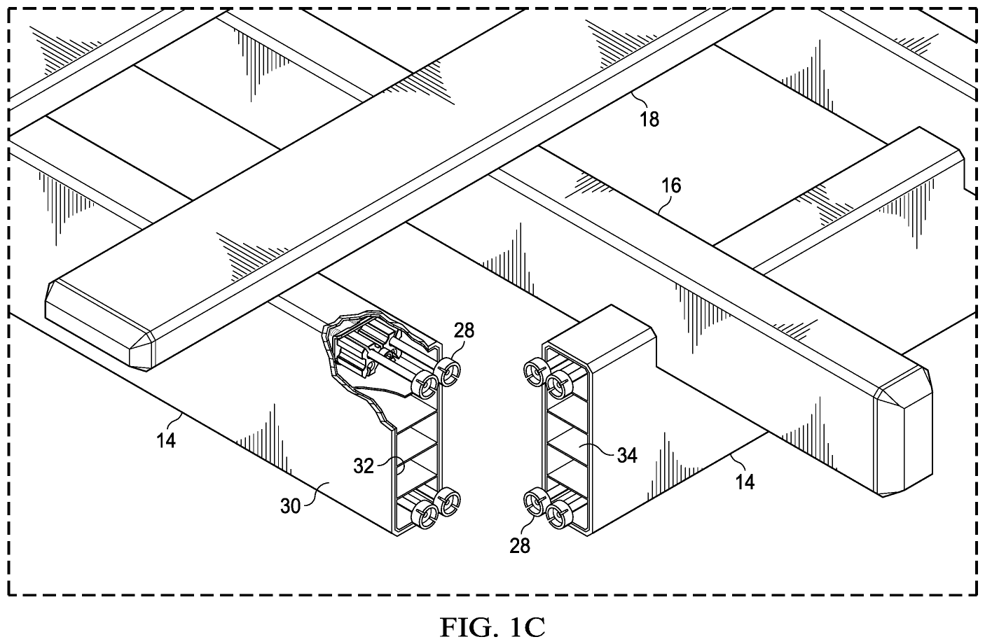

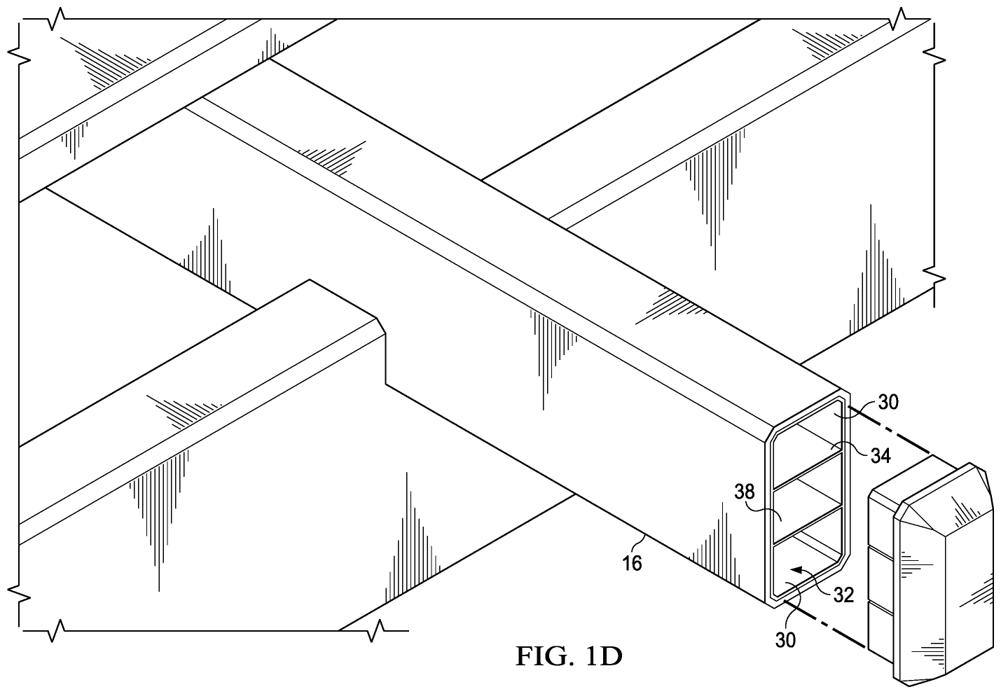

FIG. 1A is a perspective view of a pergola 10. The pergola 10 may be sold as a kit to allow the purchaser to construct the pergola using the internal connector system disclosed. The pergola 10 includes four tiered posts 12 disposed at each corner of the pergola 10. Each tiered post 12 is connected to a pair of perimeter beams 14. The four perimeter beams 14 form the perimeter of the pergola and are held up by the tiered posts 12. According to an alternate embodiment, the posts 12 may be uniform in shape, such that the posts are not tiered. At least one pair of opposed perimeter beams 14 is connected to a plurality of crossbeams 16. The crossbeams 16 support the rafters 18, and the rafters 18 may be secured to the crossbeams 16 conventionally using fasteners received through the walls of the rafter 18 and the crossbeams 16. The perimeter beams 14 are connected to the posts 12 using an internal connector system that hides the fasteners within the structural members (i.e. posts and beams). Similarly, the crossbeams 16 are connected to the perimeter beams 14 using an embodiment of the disclosed internal connector system, which hides the fasteners within the beams, as explained in further detail below. The top of the posts may receive a post cap 20, and the ends of the crossbeams 16 may receive a beam cap 22. Although the structural members are shown with square or rectangular cross-sections in the figures, this disclosure contemplates a variety of cross-sectional shapes for the structural members including circular. In an embodiment with structural members with a circular cross-section, the internal channels may have a square or rectangular cross-section to correspond with the locking features of the disclosed internal connector system.

FIG. 1B is a detailed view with portions cut away to show the connection between the tiered post 12 and the perimeter beams 14 using the disclosed internal connector system. The tiered post 12 is a hollow structure formed by external walls 24 and internal walls 26. According to certain embodiments, the tiered post may be formed of a composite material that includes an extruded metal core, for example an extruded aluminum core. The external walls 24 may include a composite material that is co-extruded, glued, or otherwise applied to the external metal wall to give the tiered post 12 an appearance of a wooden structure. The internal walls 26 provide rigidity to the tiered post 12. According to an embodiment, the internal walls 26 are spaced apart and parallel to the external walls 24 and run the length of the tiered post 12. According to an alternate embodiment, the tiered post 12 may be formed of a polymeric material that may be formed by extrusion or other polymeric forming process.

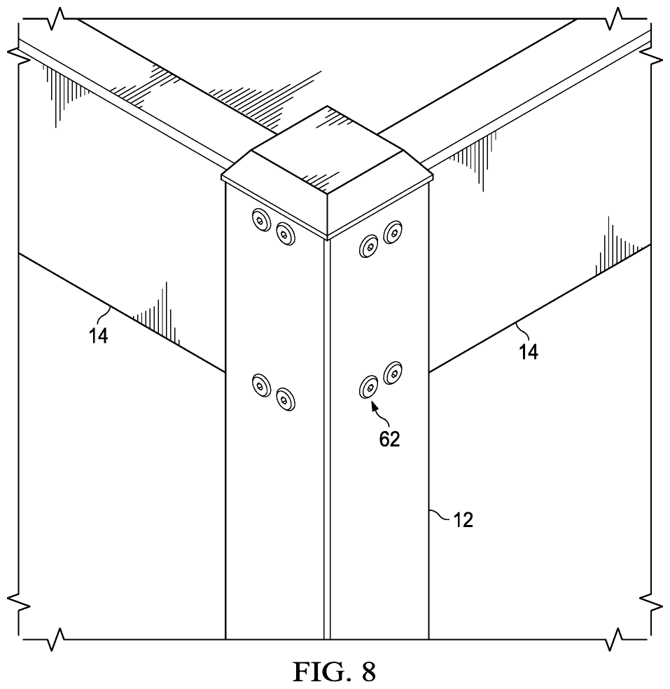

The tiered post 12 may be any suitable size, for example the tiered post 12 may be sized similarly to conventional wooden structural members. The tiered posts 12 may have a cross-sectional area of 8″×8″ or 6″×6″ or 4″×4″. According to certain embodiments, the 8″×8″ post and the 6″×6″ post allow sufficient room internal to the internal walls 26 for the bolt heads 28 to be reached and turned with a suitable tool. The smaller sized tiered post, for example a 4″×4″ cross-section post, may not have sufficient interior room for a tool to be used to secure the internal bolts, and therefore the bolts may be may extend entirely through the tiered post 12, as shown in more detail with respect to FIG. 8.

FIG. 1C shows a similar view to FIG. 1B with the tiered post 12 removed to show the internal features of the perimeter beams 14. Each of the perimeter beams 14 may have an extruded metal core or skeleton, for example an extruded aluminum core, similar to the tiered posts described above. The perimeter beams 14 include four external walls 30 that may be extruded aluminum with a composite surface that has an appearance of a conventional wood structural member, for example the perimeter beam 14 may have an appearance similar to natural timber. The perimeter beam 14 may have a plurality of channels 32 that run the length of the perimeter beam 14. The channels 32 are formed by the internal walls 34. For example, a first internal wall 34 may form a channel with an external wall that 30, and a second internal wall 34 may form a second channel with the first internal wall 34. A third internal wall 34 may form one channel 32 with the external wall 30 and another channel with the internal wall 34. The internal walls 34 provide rigidity for the perimeter beam 14, and also form the channels 32 that receive the internal connector system, as described in more detail below. The channels 32 are sized depending on the desired overall cross-sectional area of the perimeter beam 14 or other structural member.

The crossbeams 16 include features similar to the perimeter beam 14 in that it is an extruded structural member with a extruded metal core or skeleton, for example an extruded aluminum core. The exterior of the crossbeam 16 is formed of four metal external walls 30 that have an appearance of a natural wooden structural member. Similar to the perimeter beam 14, the crossbeam 16 includes a plurality of channels 32 formed at least in part by internal walls 34. They internal walls 34 provide structural rigidity for the crossbeams 16 and also form the channels 32 that hold the internal connector system, as described in more detail below. According to an alternate embodiment, the crossbeams 16 may be formed of a polymeric material that may be formed by extrusion or other polymeric forming process.

According to one embodiment, the tiered posts 12, the perimeter beams 14, the crossbeams 16, and the rafters 18 may be extruded aluminum profiles that make up the structural core or skeleton of the structural member including the internal walls. The external walls may be formed of a combination of the extruded aluminum and a cap of a wood-particle/polymer composite material that may be co-extruded with an engineered flexible adhesive to form the outer shell giving the appearance of natural timber. As discussed above, the perimeter beam 14 may include four or five channels 32 because it has a cross-sectional area, for example two inches-by-six inches. The crossbeam 16 may have three channels 32 because it has a smaller cross-sectional area, for example one inch-by-four inches, than that of the perimeter beam 14. Any suitable number of channels 32 may be included depending on the desired cross-sectional area of the structural member.

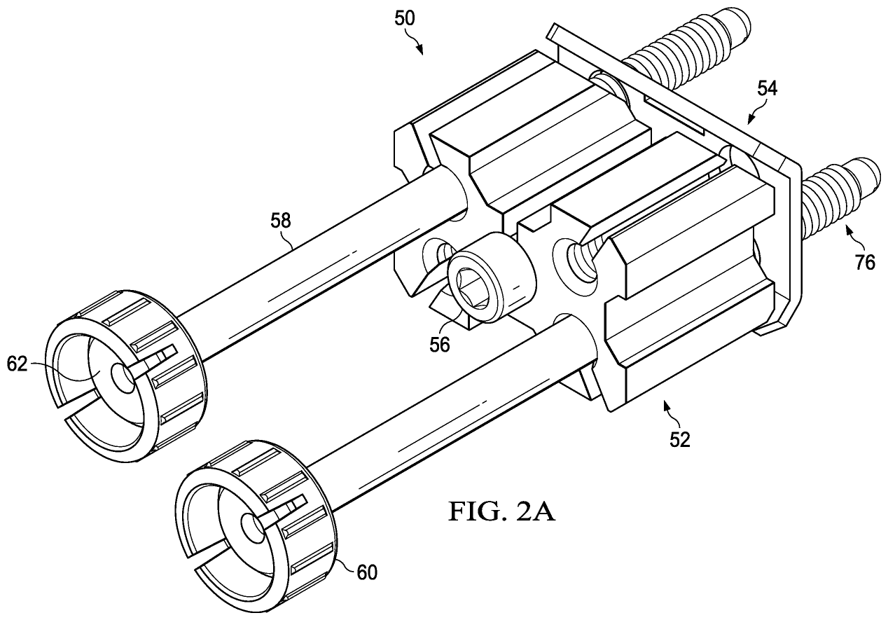

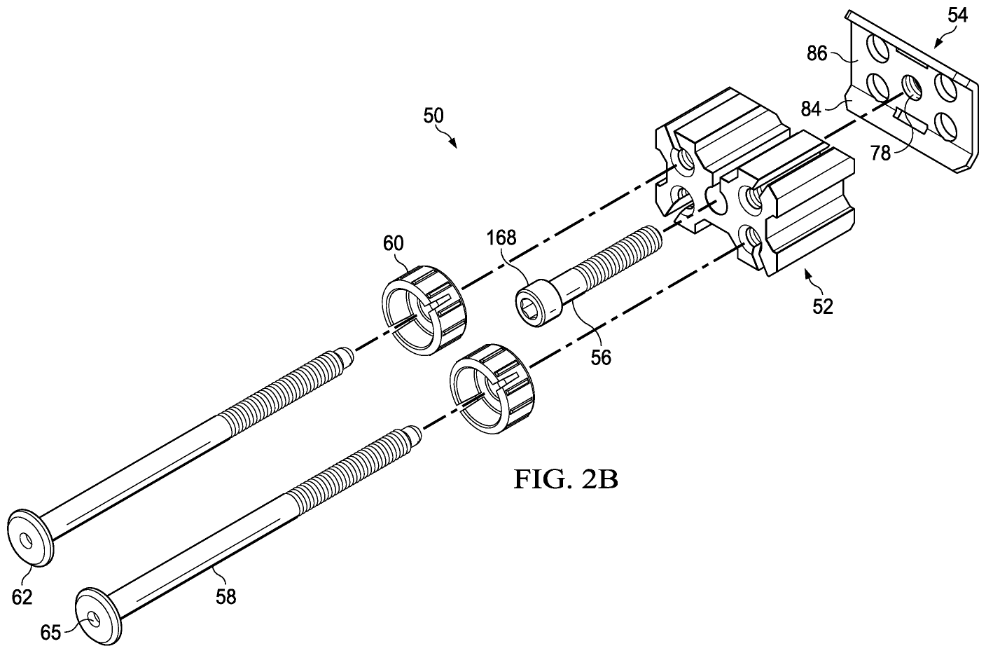

FIG. 2A is a perspective view of an internal connector system 50. FIG. 2B is an exploded perspective view of the internal connector system 50. The internal connector system 50 includes a connector block 52 and a lock plate 54. The lock plate 54 is coupled to the connector block 52 by a locking screw 56. Tightening the locking screw 56 draws the lock plate 54 toward the connector block and expands the lock plate 54 such that it impinges on the walls 30, 34 of the channels 32 of the structural member, for example the perimeter beam 14 or the crossbeam 16. More specifically, an upper and lower wings 88 of the lock plate 54 are bent (i.e. elastically deformed) by the connector block 52. The wings 88 are bent to increase an angle the respective wing 88 forms with a body 86 of the lock plate 54. The expansion of the lock plate 54 causes the wings 88 to impinge on the walls of the structural members (i.e. the perimeter beam 14 or the cross beam 16) and secures the lock plate 54 and the connector block 52 within the channel 32. The connector block 52 may then receive one or more bolts 58, which secure one structural member to the structural member that includes the connector block 52.

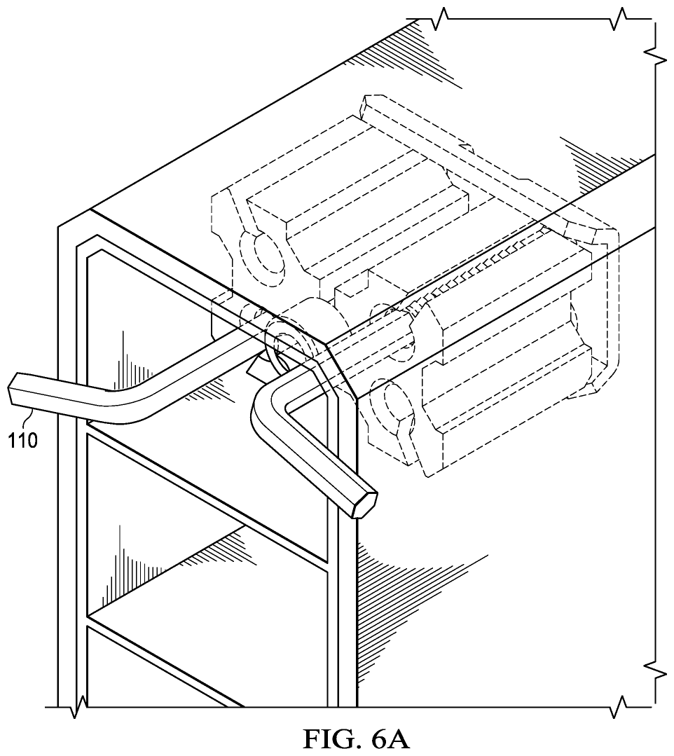

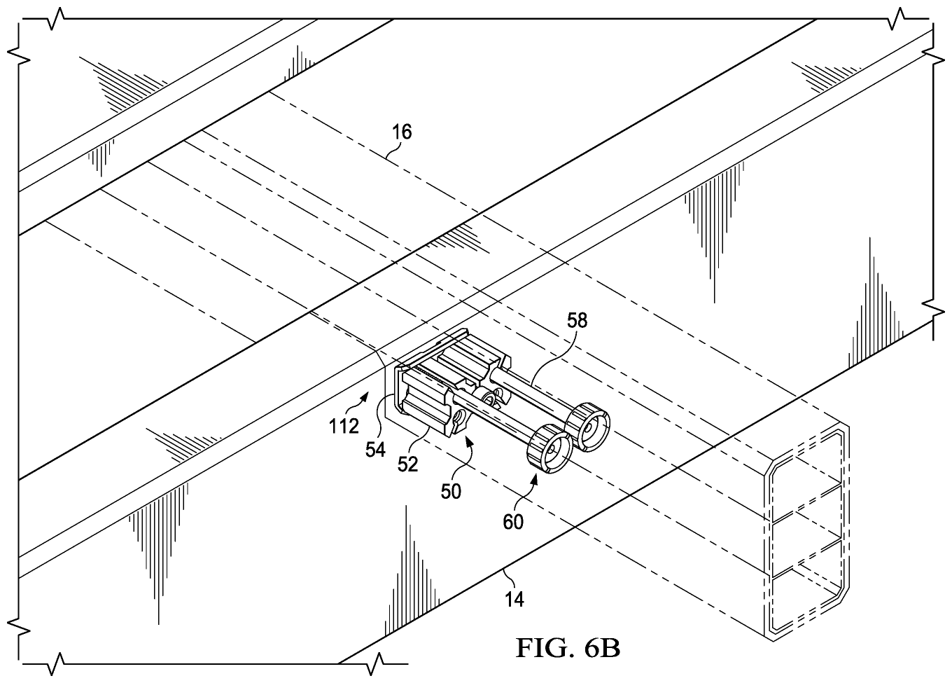

For example, a connector block 52 may be received in a channel 32 of a perimeter member 14, and the locking screw may be tightened such that the lock plate 54 impinges on an internal wall 34 and an external wall 30 and thereby secures the lock plate 54 and connector block 52 assembly within the channel 32. A bolt 58 may be received through the internal wall 26 and the external wall 24 of the tiered post 12 and threaded into the connector block 52 to secure the tiered post 12 to the perimeter member 14. Similarly, the connector block 52 and lock plate 54 may be secured within a channel 32 of a crossbeam 16, and the bolt 58 may secure the crossbeam 16 to the perimeter beam 14, as shown in FIG. 6B.

In this manner, the internal connector system 50 including the head 62 of the bolt 58 is disposed within the structural members (i.e. tiered posts 12, perimeter beams 14, and crossbeams 16) and hidden from view. Alternatively, the bolt head 62 may be disposed external to the structural members. According to one embodiment, a knob 60 may surround the head 62 of the bolt 58 and allow hand tightening of the bolt 58 at least partially because the user may grip the knob 60 and thereby turn the head 62 and the bolt 58.

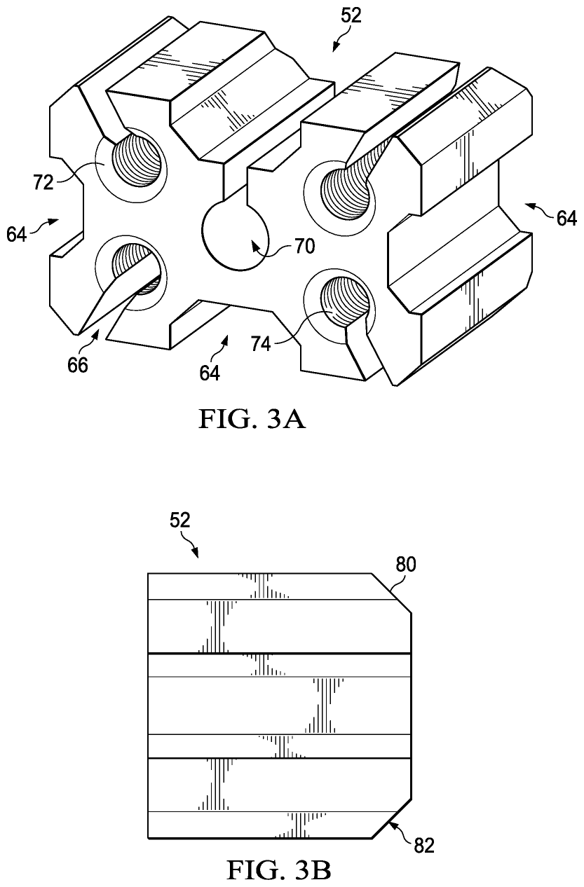

Reference is made to FIG. 3A, which is a perspective view of the connector block 52 and to FIG. 3B, which is a side view of the connector block 52. The connector block 52 may be a generally block shaped metal member with features formed therein. According to an embodiment, the connector block 52 may be formed by extrusion of a metallic material. For example, the connector block 52 may be an extruded aluminum block that is cut to the size shown from a larger length blank extrusion. The extrusion die may include features that form voids and/or through holes in the connector block 52. The voids and/or through holes may be further formed by secondary operations, for example a thread may be machined or otherwise formed in one or more of the through holes that are first formed by extrusion. According to an alternate embodiment, the connector block 52 may be formed of a polymeric material that may be formed by extrusion or other polymeric forming process. A polymeric connector block 52 may be employed in applications where the internal connector system 50 must withstand a lighter load, for example in non-architectural applications.

In the embodiment shown in FIGS. 3A and 3B, the connector block 52 includes a center through hole 70 and four outer through holes 72. According to alternate embodiments, the connector block 52 may include more or fewer outer through holes 72. As will be discussed below, the four outer through holes 72 allow the bolts 58 to be received in blocks. The four outer through holes 72 allow flexibility with positioning of the bolts 58 when joining structural members. The outer through holes 72 include a thread 74 that is configured to engage with the corresponding male thread 76 of the bolt 58. Other threaded male components may also be received in threaded engagement with the outer through holes 72, for example a block locating tool 110, as shown and described with respect to FIG. 6A.

The center through hole 70 may be formed as a bore without a thread to allow the locking screw 56 to be received through the center through hole 70 and be threaded to a corresponding threaded through hole 78 in the lock plate 54. With reference to FIG. 3B, the side view of the connector block 52 shows an upper chamfer 80 and a lower chamfer 82. The angle of both the upper chamfer 80 and the lower chamfer 82 correspond to angles of between the wings 84 and the body 86 of the lock plate 54 when the lock plate 54 is expanded by the connector block 52. According to one embodiment, an angle of the upper chamfer 80 and an angle of the lower chamfer 82 may each be in a range of 40-50 degrees, for example 45 degrees. According to an alternate embodiment, one or both of the chamfers 80, 82 may be omitted. In this embodiment, the lock plate 54 expands upon being drawn into tight engagement with the rear portion of the connector block 52, and the portions of the connector block 52 that contact the wings 88, 90 cause the lock plate 54 to expand.

The connector block 52 may include one or more perimeter voids 64 to provide a unique shape to the connector block 52, and the perimeter voids 64 also allow less material, i.e. aluminum, to be used to extrude the connector block 52. Alternatively, the connector block 52 may be formed without the perimeter voids or with differently shaped perimeter voids. According to certain embodiments, the center through hole 70 and the outer through holes 72 may not have material completely surrounding the through holes 70, 72, as shown in FIG. 3A. The incomplete through holes 70, 72 allows the majority of the walls of the through holes 70, 72 to be formed by the extrusion process such that the through holes 70, 72 can perform their function of holding a threaded connector such as the bolt 58 or the locking screw 56 to be securely received in the respective through hole 70, 72. As such manufacturing efficiency is facilitated because a secondary drilling operation is not necessary to form the through holes from an extruded blank. According to an alternate embodiment, the connector block 52 may be machined from a billet of metal, and the through holes 70, 72 may be drilled through the thickness of the block 52. In this embodiment, the walls of the through holes would completely surround the through hole 70, 72.

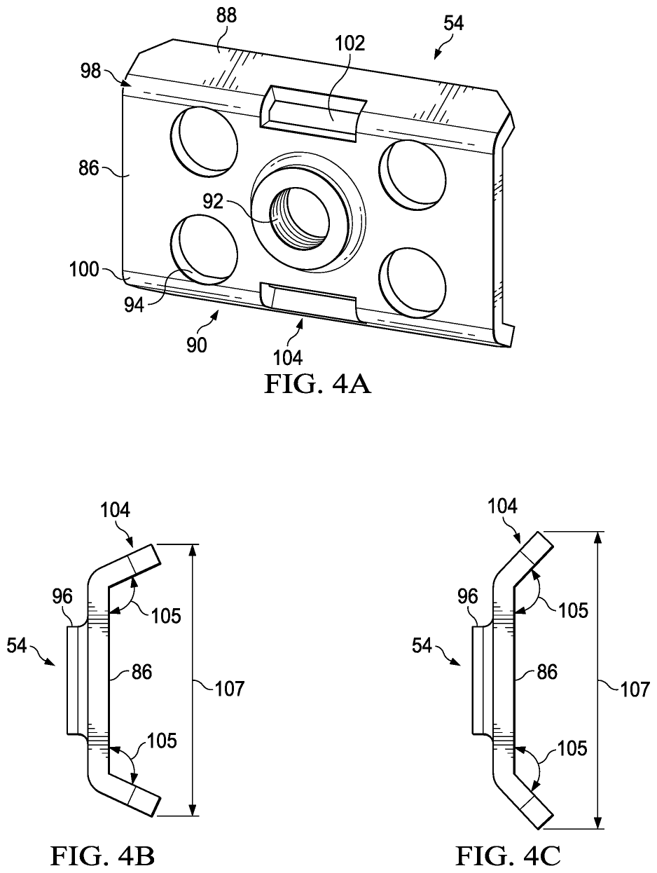

Reference is made to FIGS. 4A and 4B, which show a perspective view and a side view respectively of the lock plate 54. The lock plate 54 includes a body 86, an upper wing 88 extending from the body 86, and a lower wing 90 extending from the body 86. The lock plate 54 may be formed of a rigid metal, for example stainless steel. According to one embodiment, the lock plate is formed of cold rolled steel with a thickness of approximately 0.08 inches. The body 86 is a generally flat and straight wall that defines a plurality of through holes. The body 86 includes a center through hole 92 and a plurality of outer through holes 94. The through holes 94 are disposed to align with the outer through holes 72 of the connector block 52. The center through hole 92 of the lock plate 54 is positioned to align with the center through hole 70 of the connector block 52. The center through hole 92 includes a thread that is configured to engage with the thread of the locking screw 56. According to an embodiment, an annular boss 96 extends from the body 86 and provides additional material to allow for secure engagement of the locking screw 56 and the threaded center hole 92 of the lock plate 54. The outer through holes 94 allow the bolts 58 to extend through the lock plate 54, if necessary. According to an alternate embodiment, the lock plate 54 may be formed of a polymeric material that may be formed by extrusion or other polymeric forming process. A polymeric lock plate 54 may be employed in applications where the internal connector system 50 must withstand a lighter load, for example in non-architectural applications.

An upper bend 98 is disposed at the junction of the body 86 and the upper wing 88. A lower bend 100 is disposed at the junction of the body 86 and the lower wing 90. The bends 98 and 100 allow the wings 88 and 92 to extend from the body 86 at a non-perpendicular angle. According to one embodiment, the upper wing 88 is formed by bending a flat plate to form the shape shown in FIGS. 4A and 4B. An upper portion of the flat plate may be bent approximately 65 degrees downward away from the annular boss 96. Similarly, the lower wing 90 may be formed from a lower portion of the flat plate disposed opposite the upper portion may be bent approximately 65 degrees upward, toward the upper wing 88 and away from the annular boss 96. A wing angle 105 in the relaxed state may be in a range of 100-125 degrees, for example approximately 115 degrees. Similarly, a height 107 of the lock plate 54 in a relaxed state may be in a range of 0.8-1.3 inches, for example approximately one inch.

In operation, the locking screw 56 is turned to draw the lock plate 54 toward the connector block 52. The wings 88, 90 are forced by the chamfers 80, 82 of the connector block 52 to bend toward the annular boss 96, thereby increase the height 107 of the lock plate 54 and the wing angle 105. The expansion of the height of the lock plate 54 causes the lock plate 54 to impinge and be secured to the walls of the structural members by a frictional force. FIG. 4C shows the lock plate 54 in an expanded configuration. The wing angle 105 is increased to approximately 135 degrees, and the height 107 is increased approximately 10% to approximately 1.13 inches. As discussed above, the change in wing angle 105 and height 107 is determined at least in part by the chamfer angle of the connector block 52.

According to an embodiment, an upper void 102 is formed through the upper bend 98, and a lower void 104 is formed through the lower bend 100. The upper void 102 and the lower void 104 facilitate expansion of the lock plate 54, and an increase in the wing angle 105 and the height 107, by the connector block 52. The upper void 102 facilitates elastic bending of the upper wing 88 to open the wing angle 105 between the body 86 and the upper wing 88. The lower void facilitates elastic bending of the lower wing 90 to open the wing angle 105 between the body 86 and the lower wing 90.

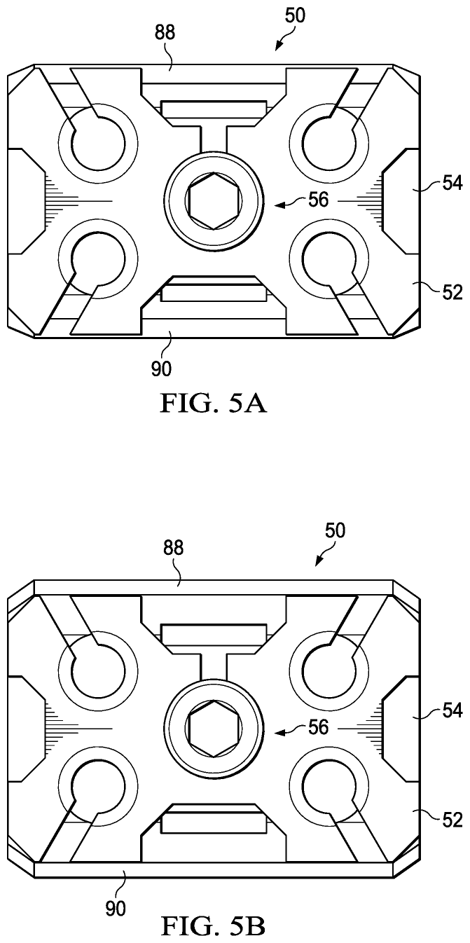

Reference is made to FIG. 5A, which shows a front elevation view of the internal connector system 50 in a relaxed state without the bolts 58. In the relaxed state, shown in FIG. 5A, the locking screw 56 may be in threaded engagement with the threaded center through hole 92 of the lock plate, but the locking screw 56 is not tightened to elastically bend the wings of the lock plate 54. FIG. 5B is a front elevation view of the internal connector system 50 with the locking screw 56 tightened to cause the expansion of the lock plate 54. Tightening the locking screw 54 draws the lock plate 54 in tight engagement with the connector block 52, and the connector block 52, more specifically the chamfers 80, 82 apply a force to each of the wings 88, 90 of the lock plate 54 and cause elastic deformation of the lock plate in a manner that the wing angle 105 between the body 86 and the wings 88, 90 increases, which causes the overall height 107 of the lock plate to increase. According to one embodiment, the height of the lock plate increases by approximately 10%, but increases in range of 7% to 15% are contemplated by this disclosure. This increase in height 107 applies a frictional force to the walls forming the channels 32 of the structural members and holds the connector block 52 and lock plate 54 assembly securely within the channel 32.

Reference is made to FIG. 6A, which is a perspective view of the internal connector system 50 in position within a channel 32 of a structural member, for example the perimeter beam 14 or the crossbeam 16. According to the embodiment illustrated in FIG. 6A, a pair of block locating tools 110 are received in threaded engagement with the outer through holes 72 of the connector block 52. The block locating tools 110 are generally L-shaped to catch on the external walls 30 of the structural member and prevent the internal connector system 50 from sliding too deep within the channel 32. The block locating tools 110 provide a repeatable and accurate positioning device for each internal connector system 50 in the channels 32 of the structural members used to build the pergola 10. Once the internal connector system 50 is properly positioned within the channel 32, the locking screw 56 may be tightened using a suitable tool. As discussed above, tightening the locking screw 56 expands the lock plate 54 and secures the lock plate 54 and the connector block 52 within the channel 32. After securing the lock plate 54 and the connector block 52 within the channel 32, the block locating tools 110 may be unscrewed and removed from the outer threaded holes 72 in the connector block 52 and used to position other internal connector systems 50 in other structural members. The present disclosure contemplates the positioning and securing the internal connector system 50 without using the block locating tools 110.

Reference is made to FIG. 6B, which shows the internal connector assembly 50 disposed in a channel 32 of a crossbeam 16. The internal connector assembly 50 has been located using the block locating tool 110 at a location proximate a notch 112 that has been formed in the crossbeam 16. The notch 112 receives the perimeter beam 14. The locking screw is tightened to draw the lock plate 54 in tight engagement with the connector block 52 and thereby expand the lock plate 54 to secure the internal connector assembly 50 within the channel 32 of the crossbeam 16. The bolts 58 are threadedly engaged with the outer through holes 72, and rotating the bolts 58 advances the bolt through the outer through holes and through the corresponding outer holes 94 of the lock plate 54. The end of the bolt 58 impinges on the outer surface of the perimeter beam 14. The bolts 58 function similarly to a set screw to hold the crossbeam 16 securely to the perimeter beam 14.

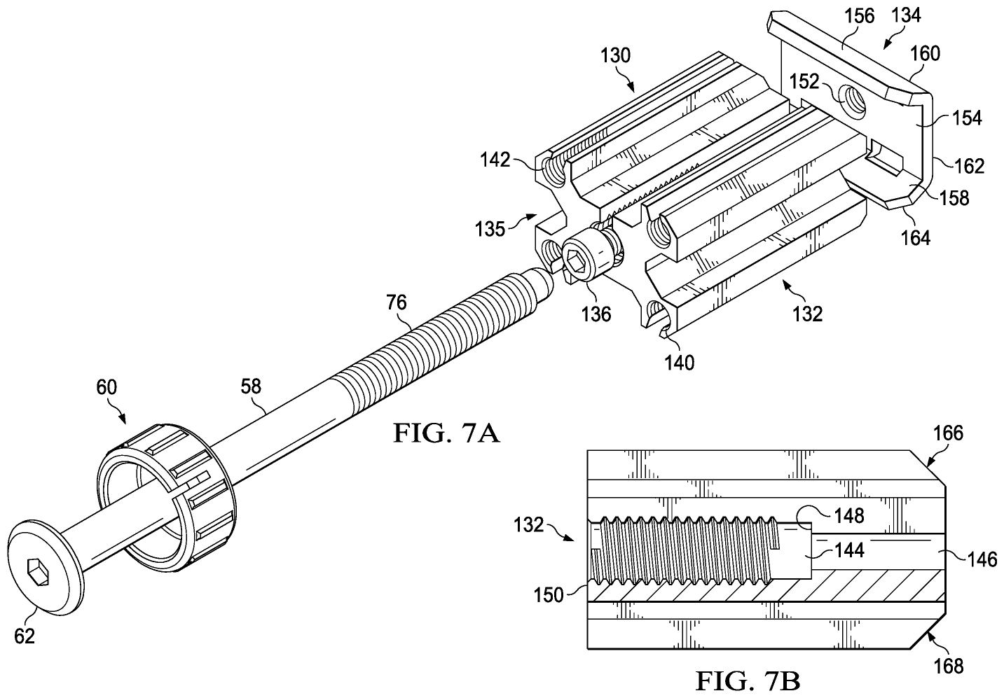

Reference is made to FIG. 7A, which shows an exploded view of an alternate embodiment of an internal connector system 130. The internal connector system 130 includes a connector block 132, a lock plate 134, and a locking screw 136. The connector block 132 and the lock plate 134 may be smaller in size than the connector block 52 and lock plate 54. However, the connector block 132 may be thicker to accommodate receiving the locking screw 36 and the bolt 58 through a common center hole. The smaller size allows the internal connector system 130 to be received and secured in smaller volume channels corresponding to smaller structural members, such as the crossbeams 16. The connector block 132 may be formed from an extruded metal, for example an extruded aluminum similar to the embodiment of the internal connector system 50. Similarly, the lock plate 134 may be formed from a metal material, for example cold rolled stainless steel with a thickness of approximately 0.08 inches. The connector block 132 includes perimeter voids 135 around its perimeter to reduce the material required to be extruded to form the connector block 132. According to an alternate embodiment, the connector block 132 may be machined out of a blank of metal, for example aluminum. The connector block 132 includes a center through hole 138 and a plurality of outer through holes 140. Each of the center through hole 138 and the outer through holes 140 may be incomplete to allow the majority of the borehole walls to be formed in the extrusion process, as described above with respect to the connector block 52. The outer through holes 140 and a portion of the center through hole 138 may have a thread formed by a secondary operation. The thread 142 formed in the outer through holes 140 is configured to engage with the threads of the block locating tool 110 to allow accurate and repeatable positioning of the connector block within the channel 32 of the structural member.

Reference is made to FIG. 7B which illustrates a cross-section of the connector block 132. A semi-blind bore 144 is formed in a subsequent operation to the initial extrusion. The semi-blind bore 144 has a diameter that is larger than a through portion 146 of the center bore 138. As such, an internal shoulder 148 is formed internal to the connector block 132. An internal thread 150 is formed in the wall of the semi-blind bore 144. The internal thread 150 is configured to engage the thread 76 of the bolt 58.

The lock plate 134 includes at least one threaded through hole 152 that is configured to threadedly engage with the locking screw 136. The lock plate 134 includes a body 154, an upper wing 156 and a lower wing 158. The wings 156 and 158 extend from the body 154 at a non-perpendicular angle and an upper bend 160 is formed at the junction of the upper wing 156 and the body 154, and a lower bend 162 is disposed at the junction of the lower wing 158 and the body 154. One or more voids 164 are formed through the bends 160, 162. The voids facilitate elastic the formation of the lock plate 134 two extend its height. According to one embodiment, the wing angle is formed and flexed (i.e. elastically deformed) as described above with respect to the wing angle 105 illustrated and described with respect to FIGS. 4B and 4C.

A user constructing a pergola may threadedly engage the threaded through hole 152 of the lock plate 134 with the thread of the locking screw 136 in loose engagement. The user may then thread the block locating tool 110 into an outer through hole 140. A second block locating tool 110 may be threaded into a second outer through hole 140. The user may then insert the connector block 132 and the lock plate 134 into the channel 32 until the block locating tool 110 catches the external wall of the structural member and the connector block will be accurately located to be in position to receive a bolt 58 to join together two structural members. The user then tightens the locking screw 136 to compress the lock plate 134 against the rear of the connector block 132. The force applied by chamfers 166, 168 of the connector block 132 to the upper wing 156 and the lower wing 158 causes the wings 156, 158 to bend such that the wing angle between the body 154 and the wings 156, 158 increases and opens such that the lock plate 134 increases in height similar to that described with respect to FIGS. 4A-5B. The thickness of the connector block 132 and the length of the locking screw 136 is such that the head of the locking screw 136 seats on the internal shoulder 148. Turning the seated locking screw 136 draws in the lock plate 134 and increases tight engagement between the lock plate 134 and the connector block 132. The expansion of the lock plate 134 causes the wings 156, 158 to impinge on the walls of the channel 32 of the structural member and thereby secure the connector block 132 and lock plate 134 assembly within the channel 32.

The structural members (i.e. tiered post 12, perimeter beams 14, and crossbeams 16) are connected by the bolt 58 being received through a first structural member and into the connector block 132 previously secured in a second structural member. More specifically, the thread 76 of the bolt 58 is received in threaded engagement with the thread 150 of the center through hole 138 of the connector block 132. The increased length of the connector block 132 allows sufficient material for the head of the locking screw 136 and the shaft of the bolt 58 to be disposed in the same semi-blind hole 144.

The connector block and lock plate assembly may be disposed within a channel 32 and internal to the structural members, but the bolt head 62 may be external to the post as shown in FIG. 8. The flexibility of the connector block 52 with respect to having four different threaded holes that can each receive a bolt 58. For example, the bolts 58 received through one wall of the post 12 can be received in the upper outer through holes 72, and the bolts received through the adjacent wall of post 12 may be received through the lower outer through holes 72. In this manner, the same internal connector system 50 may be used in two separate perimeter beams 14 that are connected to the same post without interfering with each other.

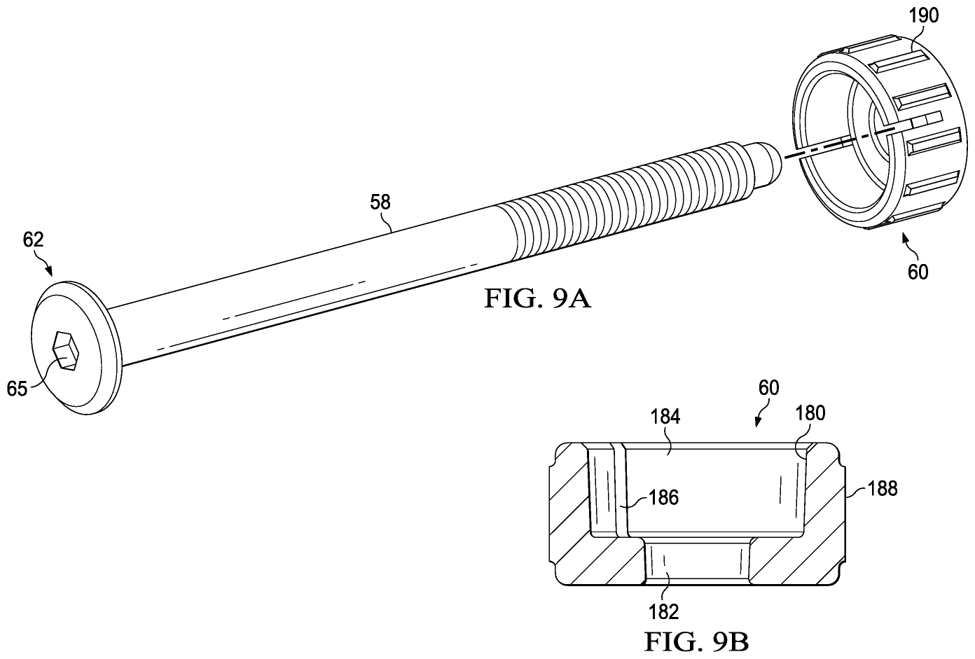

Reference is made to FIG. 9A, which illustrates a bolt 58 and a tightening knob 60. FIG. 9B is a cross-section of the tightening knob 60. The tightening knob 60 has an inner surface 180 that creates an interference and/or press fit with the head 62 of the bolt 58, as shown in FIG. 2A. The knob 60 includes a through hole 182, a semi-blind bore 184, and a shoulder 186 disposed at the junction of the semi-blind bore 184 and the through hole 182. The head 62 of the bolt seats at the shoulder 186 and an annular wall 188 surrounds the head 62. The user may grasp the knob 60, which, in certain embodiments, may include gripping features such as ribs 190. The user may grip the knob and turn the bolt 58. In this manner, the bolt 58 may be hand tightened, and the tightening operation may be completed with a tool configured to be received in a tool receiving portion 65 of the head 62 of the bolt 58.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the internal connector system for structural members and the assembled pergola as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A connector system, comprising:
a locking screw comprising a screw thread;
a connector block comprising a first bore hole sized and shaped to receive at least a portion of the locking screw, the connector block configured to engage with a bolt thread of a bolt; and
a lock plate having a plate thread configured to engage the screw thread of the locking screw, the lock plate being configured to expand upon being drawn by the locking screw into tight engagement with the connector block.

2. The connector system of claim 1 wherein the connector block further comprises a second bore hole having a block thread configured to engage with the bolt thread of the bolt.

3. The connector system of claim 1 wherein the first bore hole is partially threaded and sized and shaped to receive a head of the locking screw.

4. The connector system of claim 1 wherein the lock plate comprises a first wing forming a first wing angle with a body of the lock plate and a second wing forming a second wing angle with the body of the lock plate, wherein expanding the lock plate increases the first and second wing angles.

5. The connector system of claim 4 wherein the connector block further comprises a first chamfer operable to bend the first wing and a second chamfer operable to bend the second wing.

6. The connector system of claim 4 wherein the lock plate defines a first void disposed at a junction between the first wing and the body and defines a second void disposed at a junction between the second wing and the body.

7. The connector system of claim 1 further comprising a structural member having an internal channel, the lock plate configured to impinge on walls of the internal channel when expanded.

8. The connector system of claim 7 wherein the structural member is an extruded beam.

9. The connector system of claim 1 further comprising a block locator tool having a tool thread configured to engage with a corresponding thread of the connector block.

10. The connector system of claim 1 further comprising a tightening knob configured to receive a head of the bolt.

11. The connector system of claim 1 wherein the connector block is formed by extruding metal.

12. An internal connector system for structural members, comprising:
a locking screw comprising a screw thread;
a connector block comprising a first bore hole sized and shaped to receive at least a portion of the locking screw, the connector block configured to engage with a bolt thread of a bolt; and
a lock plate comprising a first wing extending from a body at a first wing angle and a second wing extending from the body at a second wing angle, the lock plate further comprising a plate thread configured to engage the screw thread of the locking screw, the lock plate being configured to expand upon being drawn into tight engagement with the connector block by the locking screw, wherein expansion of the lock plate increases the first wing angle and the second wing angle to thereby increase a height of the lock plate.

13. The internal connector system of claim 12 further comprising a structural member having at least one channel, and wherein when the lock plate is expanded, the first wing impinges on a first wall of the channel and the second wing impinges on a second wall of the channel when the lock plate is expanded.

14. The internal connector system of claim 13 wherein the structural member is an extruded beam.

15. The internal connector system of claim 12 wherein the first bore hole is partially threaded and sized and shaped to receive a head of the locking screw.

16. A system for joining structural members, comprising:
a first structural member comprising at least one channel;
an internal connector assembly sized and shaped to be received in the at least one channel, the internal connector assembly comprising:
a locking screw comprising a screw thread;
a connector block comprising a first bore hole sized and shaped to receive at least a portion of the locking screw, the connector block configured to engage with a bolt thread of a bolt; and
a lock plate having a plate thread configured to engage the screw thread of the locking screw, the lock plate being configured to expand and increase a frictional force between the lock plate and walls of the at least one channel upon being drawn into tight engagement with the connector block by the locking screw.

17. The system of claim 16 wherein the connector block further comprises a second bore hole having a block thread configured to engage with the bolt thread of the bolt.

18. The system of claim 16 wherein the first bore hole is partially threaded and sized and shaped to receive a head of the locking screw.

19. The system of claim 16 wherein the lock plate comprises a first wing forming a first wing angle with a body of the lock plate and a second wing forming a second wing angle with the body of the lock plate, wherein expanding the lock plate increases the first and second wing angles.

20. The system of claim 19 wherein the connector block further comprises a first chamfer and a second chamfer disposed opposite the first chamfer, the first chamfer operable to bend the first wing and the second chamfer operable to bend the second wing.
